(19) United States
(12) Patent Application Publication
(10) Pub. No.: US 2003/0114057 A1
(43) Pub. Date: Jun. 19, 2003

(54) Use of polymers containing urethane and/or urea groups for the modification of surfaces

(76) Inventors: Valerie Andre, Ludwigshafen (DE); Werner Bertleff, Viernheim (DE); Karl Häberle, Speyer (DE); J?uuml;rgen Huff, Ludwigshafen (DE); Ralf Nörenberg, B?uuml;ttelborn (DE); Wolfgang Schrepp, Heidelberg (DE); Helmut Meffert, Ludwigshafen (DE); Kati Schmidt, Ludwigshafen (DE)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(21) Appl. No.: 10/297,593

(22) PCT Filed: Jun. 13, 2001
(86) PCT No.: PCT/EP01/06719

(30) Foreign Application Priority Data
Jun. 13, 2000 (DE) 100 29 026.4
Mar. 28, 2001 (DE) 101 15 255.8

(51) Int. Cl. B32B 5/02; B32B 5/18; B32B 27/04; B32B 27/12; B32B 5/22

(52) U.S. Cl. 442/76; 442/118

(57) ABSTRACT

The present invention relates to particulate, linear, sheet-like, or three-dimensional structures which comprise, at least on their surface, a hydrophilicizing amount of at least one polymer which has urethane groups and/or urea groups, and also ammonium groups. The ammonium groups are obtained by quaternizing or neutralizing tertiary amino groups, preferably with carbonic acid.

### DESCRIPTION

The present invention relates to particulate, linear, sheet-like, or three-dimensional structures which comprise, at least on their surface, a hydrophilicizing amount of a polymer which has urethane groups and/or urea groups, and also ammonium groups. The invention further relates to a polymer composed of at least one incorporated polyisocyanate and at least one incorporated compound having at least two groups reactive toward isocyanate groups and at least one tertiary amino group, and also to a process for modifying the surface properties of particulate, linear, sheet-like, or three-dimensional structures.

Articles made from synthetic materials, such as thermosets or thermoplastics, generally have hydrophobic surface properties. However, hydrophobic properties are frequently undesirable if adhesive, or a coating or ink or paint or lacquer, is to be applied to the articles, since most adhesives, coating compositions and paints give only inadequate adhesion to hydrophobic surfaces. Hydrophobic properties are also undesirable in textile sheets, in particular in nonwovens. Examples of uses of nonwovens are cloths for cleaning, wiping or dishwashing, and serviettes. In these applications it is important that when spilled liquids, for example, such as milk, coffee, etc. are wiped up they are rapidly and fully absorbed, and that wet surfaces are dried as fully as possible. The absorption of liquids by a cleaning cloth becomes more rapid as their transport on the fiber surface becomes faster, and fibers with a hydrophilic surface are readily and rapidly wetted by aqueous liquids.

There are various conventional processes for hydrophilicizing the surfaces of films or moldings. For example, the surfaces of plastic items can be activated by gaseous fluorine. However, this process requires operations using the highly poisonous gas fluorine, with increased apparatus costs. Corona and plasma treatments are other processes used to increase the hydrophilic character of the surface of various materials, such as plastics or metals.

To improve the water-absorption properties of nonwovens, use is also made of surface-active hydrophilicizing agents, such as emulsifiers, surfactants, or wetting agents. These give excellent initial hydrophilic properties. However, a disadvantage of these nonwovens is that the hydrophilic agents are gradually washed out by water or other aqueous media.

After repeated contact with water, the product becomes increasingly hydrophobic. Another disadvantage of the known surface-active agents is a marked reduction in the surface tension of water so that in many applications, in particular in nonwovens used for sanitary or diaper applications, there is an undesirable increase in the susceptibility to permeation and in the wetting power of the liquid absorbed.

WO 98/27263 discloses stably hydrophilic polymer coatings for fibers made from polyester or from polypropylene or the like. The coating comprises certain polyoxypropylamines or polypropylene oxide polymers or hydrophilic polyester copolymers containing ethylene terephthalate units.

WO 97/00351 describes durably hydrophilic polymer coatings for polyester fibers, polyethylene fibers, or polypropylene fibers, and for the corresponding woven fabrics. The coatings comprise hydrophilic copolyesters, and also polypropylene oxide polymers.

It is an object of the present invention to provide particulate, linear, sheet-like, or three-dimensional structures provided with hydrophilic properties, and also a process for increasing the level of surface hydrophilic properties of structures of this type.

This object is achieved by way of a particulate, linear, sheet-like, or three-dimensional structure comprising, at least on its surface, a hydrophilicizing amount of at least one polymer which has urethane groups and/or urea groups, and also ammonium groups.

Preferred embodiments of the structure of the invention are linear or sheet-like textiles. Other preferred embodiments of the structure of the invention are plastic films and plastic moldings.

For the purposes of the present invention, particulate structures encompass the range from fine pigments to macroscopic particles. They particularly include those with a particle size of from 1 nm to 10 mm, in particular from 10 nm to 1 mm, which are preferably dispersed or dispersible in a medium. Examples which may be mentioned are pigments, mineral or metallic fillers, and nonliving organic materials.

For the purposes of the present invention, linear structures are particularly fibers, filaments, yarns, threads, and the like. Sheet-like structures are particularly wovens, knits, felts, webs, or nonwovens, preferably the latter. A nonwoven is produced by laying down a web of fibers which is then consolidated by various processes to give nonwovens. For example, the web is treated with an aqueous binder, such as a polymer latex, and then, where appropriate after removal of excess binder, dried and, where appropriate, cured. Other sheet-like structures are films, paper, and comparable two-dimensional structures.

For the purposes of the present application, linear textile structures also include textile composites, e.g. carpets, backed textiles, laminated textiles, etc.

Three-dimensional structures are generally moldings of various dimensions. They include in particular moldings made from wood, from paper, from metals, from plastics, from ceramic substrates, and from woven fabrics composed of natural or synthetic fibers in the form of fluffs, tissues, etc.

Preferred embodiments of the structure of the invention are linear or sheet-like textile structures. Other preferred embodiments of the structure of the invention are plastic films and plastic moldings.

The structures used according to the invention preferably encompass at least one natural or synthetic polymeric material.

Examples of materials of this type are:

1. Polymers of mono- and diolefins, for example polypropylene, polyisobutylene, poly-1-butene, poly-4-methyl-1-pentene, polyisoprene, and polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HDPE-HMW), high-density ultra-high-molecular-weight polyethylene (HDPE-UHMW), medium-density polyethylene (MDPE), low-density polyethylene (LDPE), linear low-density polyethylene (LLDPE), and branched low-density polyethylene (VLDPE). Polyolefins, i.e. the monoolefin polymers mentioned by way of example in the section above, in particular polyethylene and polypropylene, may be prepared by various processes, in particular free-radical processes, or by way of a catalyst, the catalyst usually comprising one or more metals of group IVb, Vb, VIb, or VIII. These catalyst systems are usually termed Phillips, Standard Oil Indiana, Ziegler(-Natta), TNZ (DuPont), metallocene, or single-site catalysts (SSC).

2. Mixtures of the polymers mentioned in 1., e.g. mixtures of polypropylene with polyisobutylene, polypropylene with polyethylene (e.g. PP/HDPE, PP/LDPE), and mixtures of different polyethylene grades (e.g. LDPE/HDPE).

3. Copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, or with polymers mentioned in 1., e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

4. Hydrocarbon resins, including hydrogenated modifications of these (e.g. tackifier resins), and mixtures of polyalkylenes and starch.

5. Polystyrene, poly(p-methylstyrene), poly(α-methylstyrene).

6. Copolymers of styrene or α-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

7. Graft copolymers of styrene or a-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiend; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these with the copolymers mentioned in 6., e.g. those known as ABS polymers, MBS polymers, ASA polymers, or AES polymers.

8. Halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

9. Polymers derived from α,β unsaturated acids or from derivatives of these, for example polyacrylates and polymethacrylates, butyl-acrylate-impact-modified polymethyl methacrylates, polyacrylamides, and polyacrylonitriles.

10. Copolymers of the monomers mentioned in 9, with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

11. Polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; and copolymers of these with olefins mentioned in 1.

12. Homo- and copolymers of cyclic ethers, for example polyalkylene glycols, polyethylene oxide, polypropylene oxide, and copolymers of these with bisglycidyl ethers.

13. Polyacetals, such as polyoxymethylene, and polyoxymethylenes which contain comonomers, e.g. ethylene oxide; polyacetals modified with thermoplastic polyurethanes, with acrylates, or with MBS.

14. Polyphenylene oxides and polyphenylene sulfides, and mixtures of these with styrene polymers or with polyamides.

15. Polyurethanes derived, on the one hand, from polyethers, polyesters, or polybutadienes having terminal hydroxyl groups and, on the other hand, from aliphatic or aromatic polyisocyanates, and also precursors of these polyurethanes.

16. Polyamides and copolyamides derived from diamines and dicarboxylic acids, and/or from aminocarboxylic acids, or from the corresponding lactams, for example nylon-4, nylon-6, nylon-6,6, -6,10, -6,9, -6,12, -4,6, -12,12, -11, and -12, aromatic polyamides, e.g. those based on p-phenylenediamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

17. Polyureas, polyimides, polyamideimides, polyetherimides, polyesterimides, polyhydantoins, and polybenzimidazoles.

18. Polyesters which derive from dicarboxylic acids and dialcohols and/or from hydroxycarboxylic acids, or from the corresponding lactones, for example polyethylene terephthalate, polybutylene terephthalate, poly-1,4-dimethylolcyclohexane terephthalate, polyhydroxybenzoates, and also block polyetheresters which derive from polyethers having hydroxyl end groups; polyesters modified with polycarbonates or with MBS.

19. Polycarbonates and polyester carbonates.

20. Polysulfones, polyether sulfones, and polyether ketones.

21. Crosslinked polymers which derive from aldehydes on the one hand and from phenols, urea or melamine on the other, for example phenol-formaldehyde resins, urea-formaldehyde resins, and melamine-formaldehyde resins.

22. Drying and nondrying alkyd resins.

23. Unsaturated polyester resins which derive from copolyesters of saturated or unsaturated dicarboxylic acids with polyhydric alcohols, and also vinyl compounds as crosslinkers, and also halogen-containing, flame-retardant modifications of these.

24. Crosslinkable acrylic resins which derive from substituted acrylic esters, e.g. from epoxyacrylates, from urethane acrylates, or from polyester acrylates.

25. Alkyd resins, polyester resins, and acrylate resins which have been crosslinked by melamine resins, by urea resins, by isocyanates, by isocyanurates, by polyisocyanates, or by epoxy resins.

26. Crosslinked epoxy resins which derive from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

27. Natural polymers, such as cellulose, natural rubber, gelatine, and also their polymer-homologous chemically modified derivatives, for example cellulose acetates, cellulose propionates, and cellulose butyrates and the cellulose ethers, such as methylcellulose; and colophony resins and derivatives.

28. Binary or multiple mixtures (polymer blends) of the abovementioned polymers are also very generally suitable, e.g. PP/EPDM, nylon/EPDM or ABS, PVC/EVA, PVC/ABS, PVC/MBS, PC/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/nylon-6,6 and copolymers, PA/HDPE, PA/PP, PA/PPO, PBT/PC/ABS, and PBT/PET/PC.

Preference is given to those particulate, linear, sheet-like or three-dimensional structures which encompass at least one polymeric material selected from the group consisting of polyolefins, polyesters, polyamides, polyacrylonitrile, polyaromatics, styrene-acrylonitrile copolymers (SAN), acrylonitrile-butadiene-styrene copolymers (ABS), polyurethanes, and mixtures (polymer blends) of the abovementioned polymers.

Preferred structures used according to the invention are synthetic fibers, particularly made from polyolefins, such as polyethylene or polypropylene, polyesters, polyacrylonitrile, or polyamides, e.g. nylon-6 or nylon-6,6.

Preferred structures used according to the invention are sheet-like structures, and in particular films or foils. These preferably encompass a polymer selected from the group consisting of polyolefins, such as polyethylene and/or polypropylene, polymers of halogenated monomers, e.g. polyvinyl chloride and/or polytetrafluoroethylene, polyesters and mixtures of these.

Another preferred structure used according to the invention is a molding. This preferably encompasses at least one polymeric material selected from the group consisting of polyolefins, e.g. polyethylene and/or polypropylene, polyaromatics, such as polystyrene, polymers of halogenated monomers, for example polyvinyl chloride and/or polytetrafluoroethylene, polyesters, polyacrylonitrile, styrene-acrylonitrile copolymers, acrylonitrile-butadiene-styrene copolymers, polyamides, such as nylon-6 and/or nylon-6,6, polyurethanes and mixtures of these.

According to the invention, for modifying the surface properties use is made of at least one polymer which has urethane groups and/or urea groups, and also ammonium groups.

Preference is given to polymers which incorporate

a) at least one polyisocyanate, and

b) at least one compound having at least two groups reactive toward isocyanate groups and also having at least one tertiary amino group.

At least some of the tertiary amino groups of component b) in this polymer are present in the form of ammonium groups. Charged cationic groups can be produced from the tertiary amine nitrogen atoms of the compounds of component b) and/or of the polymer either by protonation or by quaternization. At least some of the tertiary amino groups in the polymer are then in the form of the products of their reaction with at least one neutralizing (protonating) and/or quaternizing agent. In a particularly preferred embodiment the neutralizing agent is carbonic acid.

The polyisocyanates a) are preferably those selected among compounds having from 2 to 5 isocyanate groups, isocyanate prepolymers having an average number of from 2 to 5 isocyanate groups, and mixtures of these. Other suitable compounds are those which in addition or instead of free isocyanate groups have functional groups which liberate isocyanate groups or react like isocyanate groups. Examples of these are compounds having capped isocyanate groups, uretdione groups, isocyanurate groups, and/or biuret groups. The compounds having isocyanurate groups are in particular simple triisocyanatoisocyanurates, i.e. cyclic trimers of diisocyanates, or mixtures with their higher homologs having more than one isocyanurate ring. Compounds having biuret groups may be obtained by an addition reaction of three molecules of diisocyanate onto one molecule of water, for example. Capped isocyanate groups are produced during reaction with a blocking agent, which liberates the isocyanate groups again when the blocked isocyanate groups are heated to a temperature at least equal to what is known as the deblocking temperature. Compounds which block (cap or protect) isocyanate groups are the usual compounds known to the skilled worker. Examples of these are phenols, caprolactam, imidazoles, pyrazoles, pyrazolines, 1,2,4-triazoles, diketopiperazines, malonic esters, and oximes.

It is preferable to use aliphatic, cycloaliphatic, or aromatic diisocyanates as components a). Suitable aliphatic diisocyanates then preferably have a hydrocarbon radical having from 4 to 12 carbon atoms. Suitable cycloaliphatic or aromatic diisocyanates preferably have a cycloaliphatic or aromatic hydrocarbon radical having from 6 to 15 carbon atoms, or an araliphatic hydrocarbon radical having from 7 to 15 carbon atoms. Examples of suitable diisocyanates are tetramethylene diisocyanate, hexamethylene diisocyanate, 2,3,3-trimethylhexamethylene diisocyanate, dodecamethylene diisocyanate, 1,4-cyclohexylene diisocyanate, isophorone diisocyanate, dicyclohexylmethane diisocyanate, 2,2-bis(4-isocyanatocyclohexyl)propane, phenylene 1,4-diisocyanate, tolylene 2,4- and 2,6-diisocyanate, and isomeric mixtures of these (e.g. 80% of 2,4-isomer and 20% of 2,6-isomer), naphthylene 1,5-diisocyanate, diphenylmethane 2,4- and 4,4′-diisocyanate, o- and m-xylylene diisocyanate, tetramethylxylylene diisocyanate, the isomers of bis(4-isocyanatocyclohexyl)methane, e.g. the trans/trans, cis/cis, and cis/trans isomers, and also mixtures of these. Diisocyanate mixtures whose use is preferred are the isomeric mixtures of tolylene diisocyanate and diphenylmethane diisocyanate, and in particular a tolylene diisocyanate isomeric mixture of about 80% of 2,4-isomer and about 20% of 2,6-isomer. Preference is also given to mixtures which encompass at least one aromatic and at least one aliphatic and/or cycloaliphatic diisocyanate. The mixing ratio here of aliphatic and/or cycloaliphatic to aromatic diisocyanates is preferably in the range from about 4:1 to 1:4. Particular preference is given to mixtures which comprise tolylene, 2,4- and/or 2,6-diisocyanate, and also hexamethylene diisocyanate and/or isophorone diisocyanate. An example of a suitable triisocyanate is triphenylmethane 4,4′,4″-triisocyanate. Other suitable materials are isocyanate prepolymers and polyisocyanates obtainable by addition reactions of the abovementioned diisocyanates onto polyfunctional hydroxyl- or amine-group-containing compounds. Examples of these are the low-molecular-weight adducts of 3 mol of diisocyanate, such as hexamethylene diisocyanate, isophorone diisocyanate, etc., onto trihydric alcohols, e.g. trimethylolpropane, having a molar mass generally not above 400 g/mol. Preference is given to the use of hexamethylene diisocyanate, isophorone diisocyanate, or a mixture of these.

In the compounds of component b), the groups reactive toward isocyanate groups are preferably those selected among hydroxyl groups, primary and secondary amino groups, and thiol groups. Depending on these groups, the resultant polymers have urethane groups, urea groups, and/or thiocarbamate groups.

Examples of suitable compounds b) are tertiary amines in which the amine nitrogen atom has three substituents selected among hydroxyalkyl groups and/or aminoalkyl groups. Other suitable compounds b) are tertiary amines where the amine nitrogen atom has two hydroxyalkyl or aminoalkyl groups and another group selected among alkyl, cycloalkyl, aryl, and aralkyl.

Component b) preferably encompasses at least one compound of the formulae

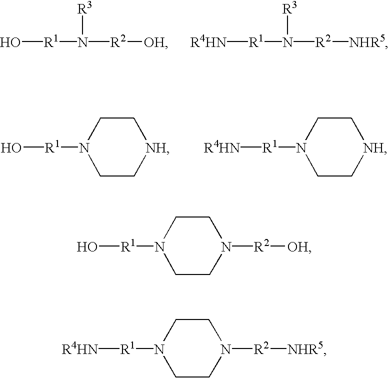

where

R¹ and R², which may be identical or different, are C₂-C₈-alkylene,

R³ is C₁-C₆-alkyl, phenyl or phenyl-C₁-C₄-alkyl and

R⁴ and R⁵, which may be identical or different, are H or C₁-C₆-alkyl.

Particularly preferred compounds b) are bis(aminopropyl)methylamine, bis(aminopropyl)piperazine, methyldiethanolamine and mixtures of these.

Other suitable compounds b) are polyethers which have at least one tertiary nitrogen atom and at least two groups reactive toward isocyanate groups, preferably two hydroxyl groups. Examples of ways of obtaining these are alkoxylation of primary amines, e.g. methylamine, or alkoxylation of diamines which have primary or secondary amino groups, e.g. N,N′-dimethylhydrazine, by conventional processes known to the skilled worker. The number-average molar mass of the polyethers is preferably in the range from 500 to 6000 g/mol.

In addition to components a) and b), the polymers used according to the invention may incorporate other components conventionally used for preparing polyurethanes and, respectively, polyureas. Examples of these are compounds other than component b) having at least two groups reactive toward isocyanate groups and conventionally used as chain extenders.

The additional components of the polymers are preferably diols, diamines, amino alcohols, or a mixture of these. The molecular weight of these compounds is preferably in the range from about 56 to 500.

It is preferable for the additional component used to be diols. Examples of diols which may be used are ethylene glycol, propylene glycol, butylene glycol, neopentyl glycol, cyclohexanedimethylol, di-, tri-, tetra-, penta- or hexaethylene glycol, and mixtures of these.

Examples of suitable additional amino alcohols are 2-aminoethanol, 2-(N-methylamino)ethanol, 3-aminopropanol, 4-aminobutanol, 1-ethylamino-2-butanol, 2-amino-2-methyl-1-propanol, 4-methyl-4-amino-2-pentanol, etc. Examples of suitable additional diamines are ethylenediamine, propylenediamine, 1,4-diaminobutane, 1,5-diaminopentane, and 1,6-diaminohexane.

Other suitable diamines are those of the formula R^{a}—NH—(CH₂)₂₋₃—NH₂, where R^{a} is C₈-C₂₂-alkyl or C₈-C₂₂-alkenyl, and the alkenyl radical may have 1, 2 or 3 non-adjacent double bonds. The molecular weight of these diamines is preferably in the range from about 160 to 400.

Examples of other suitable diamines which are conventionally used as chain extenders are hexamethylenediamine, piperazine, 1,2-diaminocyclohexane, 1,3-diaminocyclohexane, 1,4-diaminocyclohexane, neopentanediamine, 4,4′-diaminodicyclohexylmethane, etc.

The abovementioned additional components may be used individually or as a mixture. It is preferable to use no chain extenders.

The polymers used according to the invention may also incorporate at least one other compound with one group (terminator) reactive toward isocyanate groups. This group is preferably hydroxyl, or primary or secondary amino. Examples of suitable compounds with one group reactive toward isocyanate groups are monofunctional alcohols, such as methanol, ethanol, n-propanol, isopropanol, etc. Other suitable compounds are amines having one primary or secondary amino group, e.g. methylamine, ethylamine, n-propylamine, isopropylamine, dimethylamine, diethylamine, di-n-propylamine, diisopropylamine, etc. Other suitable terminators are those which have one group reactive toward isocyanate groups and at least one tertiary amino and/or ammonium group. Examples of these are N,N-dialkylamino alcohols and N,N-dialkylamino amines.

Preference is given to polymers which have a number-average molecular weight in the range from about 1000 to 50000, preferably from 2000 to 20000.

The polymers preferably have an ammonium content of from 0.1 to 5 mol of ammonium/kg, preferably from 0.5 to 3 mol/kg (mol of acid/kg of polymer).

The content of urethane groups and/or urea groups is preferably in the range from 2 to 8 mol/kg, particularly preferably from 3 to 8 mol/kg, in particular from 4 to 8 mol/kg.

Quarternary groups can be produced from the tertiary amine nitrogen atoms of the compounds of component b) and, respectively, of the polymers which incorporate component b) either, for example, by protonation, e.g. using carboxylic acids, such as lactic acid, or mineral acids, such as phosphoric acid, sulfuric acid, or hydrochloric acid, or by quaternization, e.g. using alkylating agents, such as C₁-C₄-alkyl halides or C₁-C₄-alkyl sulfates, benzyl halides, etc. Examples of these alkylating agents are ethyl chloride, ethyl bromide, methyl chloride, methyl bromide, dimethyl sulfate, and diethyl sulfate. Depending on the intended use, the neutralization and/or quaternization carried out may be partial, e.g. from 10 to 90%, or complete, i.e. 100%. The neutralization may take place prior to, during or after the polyaddition.

In one particularly preferred embodiment, the neutralizing agent used comprises carbonic acid. The carbonic acid may be used in the form of an aqueous solution, or gaseous, solid or liquid carbon dioxide, or in the form of hydrogen carbonate, in particular in the form of hydrogen carbonate with monovalent countercations, such as alkali metal cations, e.g. sodium, potassium, lithium, or a mixture of these. The carbonic acid is preferably used in the form of carbon dioxide. The carbon dioxide may be added at atmospheric pressure or at superatmospheric pressure, e.g. at up to 100 bar. If the aqueous solution of the neutralized polymer is freed from a cosolvent, e.g. one used as compatibilizer during the polyaddition, the removal of the solvent advantageously takes place with continuous feed of carbonic acid, in particular as carbon dioxide.

It has been found that polymers in which at least some of the tertiary amino groups are present as their reaction products with carbonic acid exhibit particularly good hydrophilicizing action and also have high permanence, i.e. on contact with aqueous solvents the polymers are not leached out, or are only slowly leached out, from surfaces which have been treated with the polymers.

The invention also provides a polymer which incorporates

a) at least one polyisocyanate, and

b) at least one compound having at least two groups reactive toward isocyanate groups and also having at least one tertiary amino group,

where at least some of the tertiary amino groups are present in the form of the products of their reaction with at least one neutralizing and/or quaternizing agent.

The polymers of the invention and the polymers used according to the invention are prepared by reacting at least one polyisocyanate a) with at least one compound of component b), and also, where appropriate, with additional compounds having groups reactive toward isocyanate groups. The ratio here of NCO equivalent of component a) to active hydrogen atom equivalent of components b) and, where appropriate, of additional compounds is generally in the range from about 0.6:1 to 1.4:1, preferably from 0.9:1 to 1.1:1, in particular from 0.9:1 to 1:1. The reaction may take place without solvent or in a suitable inert solvent or solvent mixture. Preference is given to solvents with unlimited miscibility with water. Preference is further given to solvents which have a boiling point in the range from about 40 to 100° C. at atmospheric pressure. Aprotic polar solvents are suitable, for example tetrahydrofuran, ethyl acetate, N-methylpyrrolidone, dimethylformamide, dimethylacetamide, and preferably ketones, such as acetone or methyl ethyl ketone. If desired, the reaction may take place in an atmosphere of inert gas, e.g. under nitrogen. The reaction moreover preferably takes place at ambient pressure or at superatmospheric pressure, in particular at the pressure generated by the reactants themselves under the reaction conditions. The reaction temperature is preferably in the range from about 5 to 180° C., in particular from 20 to 150° C. If the component b) used and also, where appropriate, additional components used are predominantly compounds whose groups reactive toward isocyanate groups are primary and/or secondary amino groups, the reaction may, if desired, take place in a solvent or solvent mixture which may have active hydrogen atoms. Besides the abovementioned compounds, use is then preferably made of alcohols, such as methanol and ethanol, mixtures of alcohols and water, mixtures of ketones and water, or else mixtures of alcohols and the abovementioned ketones. If the resultant polymers still have free isocyanate groups, these may finally be rendered inactive. The reaction time may be in the range from a few minutes to some hours. The reaction may be carried out in the presence of conventional catalysts, such as dibutyltin dilaurate, tin(II) octoate, or diazabicyclo[2.2.2]octane. Suitable polymerization apparatus is known to the skilled worker. Examples of this are stirred tanks, if desired equipped with devices to dissipate the heat of reaction. If use is made of an organic solvent in preparing the polymers, this may then be removed by conventional processes known to the skilled worker, e.g. by distillation at reduced pressure. It is also possible to add water to the polymer prior to separating off the solvent. High-boiling solvents may, if desired, also remain in the solution, but the proportion of these should preferably be not above 10% by weight, based on the weight of the polymer.

The polymers may be used in mixtures or in combination with surface-active substances, e.g. anionic, nonionic, or cationic surfactants or, respectively, wetting agents. They may also be used in a mixture with other polymers, and this can in some circumstances also strengthen the surface-modifying action.

The polymers of the invention and the polymers used according to the invention having urethane groups and/or urea groups and ammonium groups are advantageously suitable for modifying the surface properties of particulate, linear, sheet-like, or three-dimensional structures. For the purposes of the present invention, the expression “modifying the surface properties” is interpreted widely. This includes especially hydrophilicization, which for the purposes of the present invention is generally an increase in the wettability with water or with an aqueous liquid. Increased wettability is usually attended by more rapid and/or increased absorption of liquid and/or by improved retention of liquid, generally also under superatmospheric pressure. However, according to the invention “modifying of surfaces” also includes an improvement in adhesion, an improved antistatic effect, an anti-deposition effect, improved properties for the wearer, e.g. in the case of sanitary products, and/or improved hand.

The structures of the invention are generally advantageously suitable for any application sector where water or aqueous liquids come into contact with materials which in their unmodified state are substantively hydrophobic. Particularly relevant factors here are the rapid absorption and/or the rapid transport of water into materials which are in themselves hydrophobic. The structures of the invention may moreover generally be used advantageously wherever modifying surfaces by hydrophilicization can achieve improved adhesion properties, improved antistatic properties, improved anti-deposition properties, improved hand and/or improved wearer comfort.

The structures of the invention are advantageously suitable in or as synthetic fibers, wovens, knits, nonwovens, felts, textile composites, e.g. carpets, backed or laminated textiles, etc. They are also advantageously suitable for use in diapers, sanitary pads, cloths for cleaning, wiping or dishwashing, and serviettes, agricultural textiles, geotextiles, and also for filter applications.

The polymers of the invention and the polymers used according to the invention are suitable as hydrophilicizing agents for the abovementioned materials, in particular for synthetic fibers, for example those made from polyethylene, polypropylene, polyesters, polyacrylonitrile, or from polyamides. The polymers are also suitable for improving the printability and adhesive bondability of sheeting or films, for example those made from polyethylene, polypropylene, polyvinyl chloride, polytetrafluoroethylene, or from polyesters.

The antistatic properties of sheeting or films can also be improved by using the polymers.

The use of the polymers in association with moldings also gives an improvement in surface properties, making these more printable or more adhesive-bondable and giving them better antistatic properties. Examples of typical moldings are those made from polyethylene, polypropylene, polystyrene, polyvinyl chloride, polytetrafluoroethylene, polyesters, polyacrylonitrile, styrene-acrylonitrile copolymers (SAN), acrylonitrile-butadiene-styrene terpolymers (ABS), polyamides, such as nylon-6 or nylon-6,6, or from polyurethanes and/or mixtures of the abovementioned plastics.

The use of polymers having urethane groups and/or urea groups also leads to an improvement in the surface conductivity of hydrophobic, non-conducting materials, in particular of the abovementioned plastics, and thus improves their antistatic properties. The polymers are also suitable for reducing the susceptibility of plastic films to deposition.

Another advantage of the agents of the invention compared with known hydrophilicizing agents is that they do not lead to any significant reduction in the surface tension of water.

The processes used to equip the particulate, linear, sheet-like or three-dimensional structures of the invention with the polymers may be those usually used to hydrophilicize the abovementioned structures with hydrophilicizing agents of the prior art. To this end, the structure is usually treated with a dilute, preferably aqueous solution of the polymer in a manner usual for the nature of the structure, e.g. by rinsing, dipping, spraying, padding, or similar methods as usually used for treating textiles or films. The content of polymer in the solution is generally in the range from at least 0.01 to 20% by weight, and preferably from 0.1 to 10% by weight, based on the weight of the solution. It is preferable to use aqueous solutions of the polymers for the treatment. The required amount of polymer for hydrophilicization is absorbed by the surface and remains adhering thereto after drying. The amounts required to achieve effective hydrophilicization are reached automatically and are extremely small. For structures with a smooth surface, such as films or similar structures, as little as 0.1 mg/m² of polymer is sufficient.

In another embodiment of the process of the invention for hydrophilicizing surfaces, the polymer may also be added to the material of which the structure is composed and the structure may then be produced from this. For example, when treating thermoplastics, the polymer in the form of a solid may be compounded with the plastic. The resultant treated plastic is then further processed by conventional processes to give films, for example by extrusion, or to give fiber materials, for example by a melt spinning processes.

The ease of use of the polymers of the invention and the polymers used according to the invention permits their use in many application sectors, for example as hydrophilicizing agents for nonwovens used in diapers, hygiene inserts, agricultural textiles, geotextiles, other textiles, or filter systems, for example. The synthetic fibers treated with the polymers may themselves be further processed to give textiles. The hydrophilicization usually also results in an improvement in water-vapor permeability and capillary transport of perspiration, and a reduction in soiling by a wide variety of hydrophobic types of dirt. In addition, there is a favorable effect on soil release properties. The polymers may also be used as an antistatic treatment for plastic films or silicon wafers.

A suitable measure for assessing the hydrophilic/hydrophobic nature of the surface of a particulate, linear, sheet-like or three-dimensional structure is the contact angle of water on the respective surface (see, for example, Römpp, Lexikon Chemie, 9th Edition, p. 372 “Benetzung”, Georg Thieme Verlag (1995)). The term hydrophobic surfaces is usually used here if the contact angle of water is above 90°. The use of at least one polymer having urethane groups and/or urea groups and ammonium groups brings about a reduction in the contact angle by at least 10°, preferably by at least 30°, compared with that of the unmodified hydrophobic surface.

It is advantageous that the structures of the invention do not usually show the unfavorable effects known from the prior art on the surface tension of aqueous solutions, nor any increased susceptibility to migration.

The polymers used according to the invention, and also the structures surface-modified with the same, advantageously have particularly good compatibility with polymer melts. They are therefore generally also suitable as additives to a melt of polymeric raw materials for fibers or for moldings. However, the polymers may also be used as agents for modifying the structures by post-treatment.

The invention is further illustrated by the following non-limiting examples.

### EXAMPLES

I. Test Methods

I.1 Angle of Contact Measurement

The respective substrate is treated, with stirring, with a 0.5% strength by weight solution of the polymer for 30 min at 21° C. The specimen is then divided up, and one half is dried immediately after treatment (CA1), while the other half is dipped in distilled water for about one second and then dried (CA2). The contact angle on both specimens is determined using distilled water at room temperature.

I.2 Measurement of Hydrophilic Properties

Method A

The measurement took place on a polypropylene web. The web is treated with a aqueous 0.5% strength by weight solution of the polymer, and then dried. A drop of water is applied to the substrate to be tested. The wetting of the web by the water is assessed visually by way of a 10 point scale. Zero points here means no wetting, and 10 points means immediate run-out of the drop.

Method B

The web was pretreated as in method A. Nine drops of water were then applied to the web. The time taken for the drops to be completely absorbed into the web was determined.

I.3 Determination of Surface Tension

The measurements were carried out on 100 ml of an aqueous, 0.5% strength by weight solution of the polymer, by means of a Lauda model TElC tensiometer.

I.4 Reflectometric Determination of Affinity

As described by J. C. Dijt et al., Colloids Surf. 51 (1990) 141, a polypropylene film which was applied to a silicon wafer is brought into contact with an aqueous polymer solution. The amount adsorbed can be determined in situ by analyzing the polarization direction of a reflected beam of light.

### II. PREPARATION EXAMPLES

### Preparation Example 1

### Polyurea Made from Isophorone Diisocyanate and bis(aminopropyl)piperazine—Neutralization with Hydrochloric Acid

20.0 g (0.1 mol) of bis(aminopropyl)piperazine were dissolved in 200 g of acetone in a 4-necked flask fitted with stirrer, dropping funnel, thermometer, and reflux condenser. 22.2 g (0.1 mol) of isophorone diisocyanate were added dropwise in such a way that the temperature did not rise above 30° C. The reaction mixture was stirred at reflux for a further hour, and 110 g of HCl (1N) and 100 g of water were then added. The acetone was then distilled off under reduced pressure. This gave a polyurea solution with a solids content of 16.7% by weight and a pH of 7.2. The ammonium content of the polymer was 2.61 mol/kg. The urea content of the polymer was 4.74 mol/kg.

### Preparation Example 2

### Polyurea Made from Isophorone Diisocyanate and bis(aminopropyl)methylamine—Neutralization with Hydrochloric Acid

Using a method based on the preparation specification for the polyurea 1, a polyurea was prepared from 14.5 g (0.1 mol) of bis(aminopropyl)methylamine and 22.2 g (0.1 mol) of isophorone diisocyanate. This gave a polyurea solutions with a solids content of 25.5% by weight and a pH of 7.7. The ammonium content of the polymer was 2.72 mol/kg. The urea content of the polymer was 5.45 mol/kg.

### Preparation Example 3

### Polyurethane Made from isophorone Diisocyanate and Methyldiethanolamine—Neutralization with Hydrochloric Acid.

11.92 g (0.1 mol) of methyldiethanolamine were dissolved in 200 g of acetone in a 4-necked flask fitted with stirrer, dropping funnel, thermometer, and reflux condenser. 22.2 g (0.1 mol) of isophorone diisocyanate were added dropwise in such a way that the temperature did not rise above 30° C. The reaction mixture was stirred at reflux for a further 8 hours. 100 g of HCl (1N) were then added. The acetone was then distilled off under reduced pressure. This gave a polyurethane solution with a solids content of 29.7% by weight and a pH of 7.2. The ammonium content of the polymer was 2.93 mol/kg. The urethane content of the polymer was 5.86 mol/kg.

### Preparation Example 4

### Polyurea Made from Isophorone Diisocyanate and bis(aminopropyl)methylamine—Neutralization with Hydrochloric Acid

174 g (1.2 mol) of bis(aminopropyl)methylamine were dissolved in 1200 g of acetone in a 4-necked flask fitted with stirrer, dropping funnel, thermometer, and reflux condenser, and neutralized using 1140 g of HCl (1N). 266.4 g (1.2 mol) of isophorone diisocyanate were added dropwise to this reaction mixture within a period of 20 minutes. The reaction mixture was stirred at reflux for a further hour, and the acetone was then distilled off at reduced pressure. This gave a polyurea solution with a solids content of 36.3% by weight and a pH of 7.3. The ammonium content of the polymer was 2.59 mol/kg. The urea content of the polymer was 5.45 mol/kg.

### Preparation Example 5

### Polyurea Made from Hexamethylene Diisocyanate and bis(aminopropyl)methylamine—Neutralization with Hydrochloric Acid

Using a method similar to that for polyurea 4, a polyurea was prepared from 7.25 g (0.05 mol) of bis(aminopropyl)methylamine and 8.41 g (0.05 mol) of hexamethylene diisocyanate. This gave a polyurea solution with a solids content of 40.3% by weight and a pH of 7.4. The ammonium content of the polymer was 3.19 mol/kg. The urea content of the polymer was 6.39 mol/kg.

### Preparation Example 6

### Polyurea Made from Isophorone Diisocyanate and bis(aminopropyl)methylamine—Neutralization with Lactic Acid

29.0 g (0.2 mol) of bis(aminopropyl)methylamine were dissolved in a mixture made from 180 g of water, 200 g of acetone, and 20 g of 90% strength lactic acid in a 4-necked flask equipped with stirrer, dropping funnel, thermometer, and reflux condenser. 44.4 g (0.2 mol) of isophorone diisocyanate were added dropwise to this mixture within a period of 20 minutes. The reaction mixture was stirred at reflux for a further hour, and the acetone was then distilled off at reduced pressure. This gave a polyurea solution with a solids content of 36.4% by weight. The ammonium content of the polymer was 2.72 mol/kg. The urea content of the polymer was 5.45 mol/kg.

### Preparation Example 7

### Polyurea Made from Isophorone Diisocyanate and bis(aminopropyl)methylamine—Neutralization with Carbonic Acid

106.32 g (0.733 mol) of bis(aminopropyl)methylamine and 770 g of water were charged at room temperature to a four-necked flask equipped with stirrer, dropping funnel, thermometer, and reflux condenser. A stream of 4 l/h of carbon dioxide was passed into this solution for 60 min. 631 g of acetone were then added, and the reaction mixture was heated to 46° C., and 162.8 g (0.733 mol) of isophorone diisocyanate were added dropwise within a period of 40 min. After two hours of stirring at 50° C., the acetone was distilled off at reduced pressure, again while passing carbon dioxide at 4 l/h. This gave a polyurea solution with solids content of 25.5% by weight and a pH of 7.8.

III. PERFORMANCE-RELATED EXAMPLES

III.1 Contact Angle Measurement

Contact angle was measured as described above. The results are given in Table 1 below.

TABLE 1

| | | Contact |
|---|---|---|
| Example no. | Additive | angle CA1 |
| 1 (comparison) | No additive | 105° |
| 2 (comparison) | Commercially available alcohol | 58° |
| | ethoxylate | |
| 3 (comparison) | Commercially available | 86° |
| | hydrophilicizing polyetherester | |
| 4 | Preparation Example 1 | 9° |
| 5 | Preparation Example 2 | 7° and 11°*) |
| 6 | Preparation Example 3 | 10° |
| 7 | Preparation Example 4 | 6° |
| 8 | Preparation Example 4 | 6° |
| 8 | Preparation Example 5 | 22° |
| 9 | Preparation Example 6 | 7° and 20°*) |
| 10 | Preparation Example 7 | 10° |

*)Values measured in repeated experiment

For the polymers of the invention there is no significant difference between the CA2 values and the CA1 values. This shows that the hydrophilicizing effect continues even after rinsing with water.

III.2 Measurement of Hydrophilic Properties

Hydrophilic properties were measured as described above. The results are given in Tables 2 and 3 below.

TABLE 2
Method A

| | | Hydrophilic |
|---|---|---|
| Example No. | Additive | properties |
| 11 (comparison) | No additive | 0 |
| 12 (comparison) | Commercially available hydrophili- | 3 |
| | cizing polyetherester | |
| 13 | Preparation Example 1 | 9 |
| 14 | Preparation Example 2 | 10 |
| 15 | Preparation Example 3 | 9 |
| 16 | Preparation Example 4 | 9 |
| 17 | Preparation Example 5 | 7 |
| 18 | Preparation Example 6 | 10 |

TABLE 3
Method B

| | | Number of drops absorbed | | |
|---|---|---|---|---|
| Example | | | after | after |
| No. | Additive | immediately | 10 s | 60 s |
| 19 | No additive | 0 | 0 | 9 |
| 20 | Commercially available | 0 | 2 | 7 |
| | hydrophilicizing | | | |
| | surfactant | | | |
| 21 | Preparation Example 6 | 7 | 2 | 0 |
| 22 | Preparation Example 2 | 8 | 0 | 1 |
| 23 | Preparation Example 7 | 9 | 0 | 0 |

II.3 Determination of Surface Tension

Surface tension was measured as described above. The results are given in Table 4.

TABLE 4

| | | Surface tension |
|---|---|---|
| Example No. | Additive | [mN/m] |
| 24 (comparison) | Commercially available | 20 |
| | hydrphilicizing surfactant | |
| 25 (comparison) | No additive | 72 |
| 26 | Preparation Example 6 | 58 |
| 27 | Preparation Example 2 | 58 |
| 28 | Preparation Example 7 | 54 |

III.4 Determination of Affinity

### Example 29

A 0.05% strength by weight solution of the polymer from Preparation Example 1 was adjusted to a pH of 5. A polypropylene-modified silicon wafer was then subjected to a perpendicular flow of the resultant solution at 0.7 ml/min. A change in the detection signal compared with that from a polymer-free solution was observed, due to the absorption of the polymer. By using computer-assisted modeling of the path, a coating weight of 0.7 mg/m² is obtained from this change. This coating weight does not decrease significantly when polymer-free solution is then allowed to flow onto the surface.

Other results are given in Table 5 below. Use was made of 0.01% strength by weight solutions of the polymers from Preparation Examples 6, 2, and 7, these having been adjusted to pH 7.

TABLE 5

| Example No. | Additivie | Found |
|---|---|---|
| 30 | Commercially available | is washed off again by |
| | polycarboxylate | water |
| 31 | Preparation Example 6 | when rinsed with water |
| | | remains on the PP layer |
| 32 | Preparation Example 2 | when rinsed with water |
| | | remains on the PP layer |
| 33 | Preparation Example 7 | when rinsed with water |
| | | remains on the PP layer |

The performance-related examples show that polypropylene surfaces can be effectively hydrophilicized using the polymers of the invention or the polymers used according to the invention. None of the inventive examples here reveals any significant tendency toward foaming, whereas the commercially available alcohol ethoxylate used as comparative substance shows a marked to very marked foaming tendency, as do the conventional nonionic surfactants known from the prior art. When the polymers are used moreover no significant reduction is found in the surface tension of an aqueous solution, whereas the alcohol ethoxylate used as comparative substance markedly reduces the surface tension, as do very generally the surfactants known from the prior art and used as hydrophilicizing agents. Even when rinsed with water, the polymers remain on the treated surfaces, while a polycarboxylate used as comparative substance is washed off.

We claim:

1. A particulate, linear, sheet-like, or three-dimensional structure comprising, at least on its surface, a hydrophilicizing amount of at least one polymer which has urethane groups and/or urea groups, and also ammonium groups.

2. A structure as claimed in claim 1 in the form of a linear or sheet-like textile.

3. A structure as claimed in claim 2, in which the textile has been built up from synthetic fibers.

4. A structure as claimed in claim 1 in the form of a plastic film or of a plastic molding.

5. A structure as claimed in any of the preceding claims, where the polymer incorporates
a) at least one polyisocyanate, and
b) at least one compound having at least two groups reactive toward isocyanate groups and also having at least one tertiary amino group,
where at least some of the tertiary amino groups are present in the form of the products of their reaction with at least one neutralizing and/or quaternizing agent.

6. A structure as claimed in claim 5, where the neutralizing agent is carbonic acid.

7. A polymer composed of
a) at least one incorporated polyisocyanate, and
b) at least one incorporated compound having at least two groups reactive toward isocyanate groups and also having at least one tertiary amino group,
where at least some of the tertiary amino groups are present in the form of the products of their reaction with at least one neutralizing and/or quaternizing agent.

8. A polymer as claimed in claim 7, where the neutralizing agent is carbonic acid.

9. The use of polymers which incorporate
a) at least one polyisocyanate, and
b) at least one compound having at least two groups reactive toward isocyanate groups and also having at least one tertiary amino group,
where at least some of the tertiary amino groups are present in the form of the products of their reaction with at least one neutralizing and/or quaternizing agent, for modifying the surface properties of solid substances.

10. The use as claimed in claim 9, where the neutralizing agent is carbonic acid.

11. A process for modifying the surface properties of particulate, linear, sheet-like, or three-dimensional structures, by applying, to the surface of these, an effective amount of a polymer which incorporates
a) at least one polyisocyanate, and
b) at least one compound having at least two groups reactive toward isocyanate groups and also having at least one tertiary amino group,
where at least some of the tertiary amino groups are present in the form of the products of their reaction with at least one neutralizing and/or quaternizing agent.

12. A process for modifying the surface properties of particulate, linear, sheet-like, or three-dimensional structures, by modifying the material of which the structure is composed with an effective amount of a polymer which incorporates
a) at least one polyisocyanate, and
b) at least one compound having at least two groups reactive toward isocyanate groups and also having at least one tertiary amino group,
where at least some of the tertiary amino groups are present in the form of the products of their reaction with at least one neutralizing and/or quaternizing agent, and by producing the structure from this material.

13. A process as claimed in claim 11 or 12, where the neutralizing agent is carbonic acid.
